(19) United States
(12) Patent Application Publication
(10) Pub. No.: US 2022/0343946 A1
(43) Pub. Date: Oct. 27, 2022

(54) DATA STORAGE METHOD AND COMPOSITION

(71) Applicant: Sumitomo Chemical Co., Ltd., Tokyo (JP)

(72) Inventors: William Tarran, Godmanchester (GB); Philip Benzie, Godmanchester (GB); James Lee, Godmanchester (GB); Florence Bourcet, Godmanchester (GB)

(73) Assignee: Sumitomo Chemical Co., Ltd., Tokyo (JP)

(21) Appl. No.: 17/766,129

(22) PCT Filed: Oct. 1, 2020
(86) PCT No.: PCT/GB2020/052407

§ 371 Date: Apr. 1, 2022

(30) Foreign Application Priority Data
Oct. 1, 2019 (GB) 1914173.8

(51) Int. Cl. G11B 7/0045; G11B 7/244; C09K 11/06

(52) U.S. Cl. CPC G11B 7/0045; G11B 7/244; C09K 11/06; G11B 2007/00457; C09K 2211/1475

(57) ABSTRACT

A method of recording data to a layer (101) of a recording medium in which an organic luminescent precursor composition is irradiated with a first light beam (103) and a second light beam (105), the first light beam having a write wavelength for conversion of the organic luminescent precursor composition to an organic luminescent composition and the second light beam having a write inhibition wavelength for inhibiting conversion of the organic luminescent precursor composition to the organic luminescent composition. The second light beam has a central area and a surrounding area; an intensity of the second light beam in the central area being lower than an intensity of the second light beam in the surrounding area. The first light beam extends across the central area and the surrounding area of the second light beam surrounds the first light beam.

### BACKGROUND

Embodiments of the present disclosure relate to processes for writing data to an optical data storage medium; reading data stored on an optical storage medium using optical techniques; and compositions for writing data using an optical technique.

Optical storage media are well known, for example DVD and Blu-ray discs. However, there is a need for increasing the storage capacity of data storage media due to the ever-increasing amount of data requiring storage.

WO 2015/077815 discloses simultaneous irradiation of a region of a recording medium with a first beam having a central spot and a second beam surrounding the central spot in which a change in properties of the recording medium caused by the first beam is suppressed in a region defined by the second beam. It is disclosed that this may achieve higher resolution than would be achieved at the diffraction limit of the first beam alone.

### SUMMARY

According to some embodiments of the present disclosure, there is provided a method of recording data to a first layer of a recording medium comprising an organic luminescent precursor composition. The method includes irradiating the organic luminescent precursor composition with a first light beam and a second light beam, the first light beam having a write wavelength for conversion of the organic luminescent precursor composition to an organic luminescent composition and the second light beam having a write inhibition wavelength for inhibiting conversion of the organic luminescent precursor composition to the organic luminescent composition. The second light beam has a central area and a surrounding area; an intensity of the second light beam in the central area being lower than an intensity of the second light beam in the surrounding area. The first light beam extends across the central area and the surrounding area of the second light beam surrounds the first light beam.

Optionally, the organic luminescent precursor composition comprises an initiator wherein the initiator forms, upon irradiation with light of a write wavelength, a reactive material for initiating a conversion of an organic luminescent precursor material of the organic luminescent precursor composition to an organic luminescent material.

Optionally, the composition further comprises a co-initiator which, upon exposure to the write wavelength, reacts with the initiator to form the reactive material.

Optionally, the organic luminescent precursor material has a lower extent of conjugation than the organic luminescent material.

Optionally, the organic luminescent precursor is a non-polymeric compound.

Optionally, the organic luminescent material is a polymer.

Optionally, the reactive material is a radical compound.

Optionally, the recording medium comprises an inhibitor wherein the inhibitor, upon irradiation with light of the write inhibition wavelength, inhibits the conversion of the organic luminescent precursor composition to the organic luminescent composition.

According to some embodiments, the organic luminescent precursor composition comprises the inhibitor.

According to some embodiments, the inhibitor is disposed in a second layer of the recording medium.

Optionally the inhibitor, upon absorption of light of the write inhibit wavelength, forms an excited state which absorbs light of the write wavelength.

Optionally the inhibitor, upon absorption of light of the write inhibit wavelength, converts to a material which absorbs light of the write wavelength.

Optionally the inhibitor, upon absorption of light of the write inhibit wavelength, forms an excited state capable of receiving electrons from or transferring electrons to an excited state of the initiator.

Optionally, the organic luminescent precursor composition comprises an organic luminescent material bound to a luminescence quencher and wherein the recording medium further comprises an inhibitor and wherein:

the luminescent quencher is cleaved from the organic luminescent material or is converted to a non-quenching form upon irradiation of the organic luminescent material bound to a luminescence quencher, upon irradiation with light of the write wavelength; and

the inhibitor, upon irradiation with light of the write inhibition wavelength, inhibits the cleavage or conversion of the luminescent quencher.

The organic luminescent precursor composition comprising the organic luminescent material bound to the luminescence quencher may comprise the inhibitor and/or the inhibitor may be disposed in a second layer of the recording medium.

Optionally, the organic luminescent precursor composition comprises an organic luminescent material mixed with a luminescence quencher wherein the recording medium further comprises an inhibitor and wherein:

the luminescent quencher is, upon irradiation with light of the write wavelength, converted to a non-quenching form; and

the inhibitor, upon irradiation with light of the write inhibition wavelength, inhibits the conversion of the luminescent quencher.

The organic luminescent precursor composition comprising the organic luminescent material mixed with the luminescence quencher may comprise the inhibitor and/or the inhibitor may be disposed in a second layer of the recording medium. Optionally, the composition further comprises a matrix comprising at least one polymer.

Optionally, the recording medium is a disc.

According to some embodiments of the present disclosure there is provided a composition containing:

an organic luminescent precursor material,

an initiator for forming, upon irradiation with light of a write wavelength, a reactive material for initiating a conversion of the organic luminescent precursor to an organic luminescent material; and

an inhibitor for inhibiting formation of the reactive material upon irradiation with light of a write inhibition wavelength.

According to some embodiments of the present disclosure there is provided a composition containing:

a luminescent quencher bound to or mixed with an organic luminescent material which, upon irradiation with light of a write wavelength, cleaves from the organic luminescent material or converts to a non-quenching form; and

an inhibitor for inhibiting said cleavage or conversion.

### DESCRIPTION OF DRAWINGS

FIG. 1A is a schematic illustration of irradiation of a recording medium with first and second light beams to write data to the recording medium; and

FIG. 1B is a cross-section through plane A-A of the first and second light beams of FIG. 1A;

FIG. 1C is a plot of intensity vs distance for first and second light beams according to some embodiments

FIG. 2 shows change in photoluminescence of a solution containing an organic luminescent precursor and an initiator and a solution in which of the organic luminescent precursor only;

FIG. 3A shows a greyscale fluorescence image of a raster scanned area of a film containing an organic luminescent precursor and an initiator;

FIG. 3B shows the image of FIG. 3A in which the raster scan pattern is superimposed over the image;

FIG. 4 is a photoluminescence cross-section of the film described in FIG. 3A;

FIG. 5 is an image of a raster scanned area of a film containing an organic luminescent precursor containing a cleavable quencher;

FIG. 6 is a schematic illustration of apparatus for irradiating a structure with write and write inhibition beams; and

FIG. 7 illustrates a change in writing upon exposure of a layer containing an organic luminescent precursor composition to a write laser, with and without a collinear write inhibit laser.

The drawings are not drawn to scale and have various viewpoints and perspectives. The drawings are some implementations and examples. Additionally, some components and/or operations may be separated into different blocks or combined into a single block for the purposes of discussion of some of the embodiments of the disclosed technology. Moreover, while the technology is amenable to various modifications and alternative forms, specific embodiments have been shown by way of example in the drawings and are described in detail below. The intention, however, is not to limit the technology to the particular implementations described. On the contrary, the technology is intended to cover all modifications, equivalents, and alternatives falling within the scope of the technology as defined by the appended claims.

### DETAILED DESCRIPTION

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” Additionally, the words “herein,” “above,” “below,” and words of similar import, when used in this application, refer to this application as a whole and not to any particular portions of this application. Where the context permits, words in the Detailed Description using the singular or plural number may also include the plural or singular number respectively. The word “or,” in reference to a list of two or more items, covers all of the following interpretations of the word: any of the items in the list, all of the items in the list, and any combination of the items in the list.

The teachings of the technology provided herein can be applied to other systems, not necessarily the system described below. The elements and acts of the various examples described below can be combined to provide further implementations of the technology. Some alternative implementations of the technology may include not only additional elements to those implementations noted below, but also may include fewer elements.

These and other changes can be made to the technology in light of the following detailed description. While the description describes certain examples of the technology, and describes the best mode contemplated, no matter how detailed the description appears, the technology can be practiced in many ways. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms.

In the following description, for the purposes of explanation, numerous specific details are set forth in order to provide a thorough understanding of implementations of the disclosed technology. It will be apparent, however, to one skilled in the art that embodiments of the disclosed technology may be practiced without some of these specific details.

The present inventors have found that high resolution optical storage may be achieved by irradiating an organic luminescent precursor composition with a write beam having a write wavelength of light capable of converting the organic luminescent precursor composition to an organic luminescent composition, wherein the write beam is surrounded by a write inhibition beam having a second wavelength for inhibiting the conversion of the organic luminescent precursor composition.

The organic luminescent composition has increased luminescence, optionally at least increased by a factor of 10, as compared to the organic luminescent precursor composition from which it is formed when irradiated with light having a wavelength at a peak absorption wavelength, or a STED read wavelength as described below, of an organic luminescent material of the organic luminescent composition.

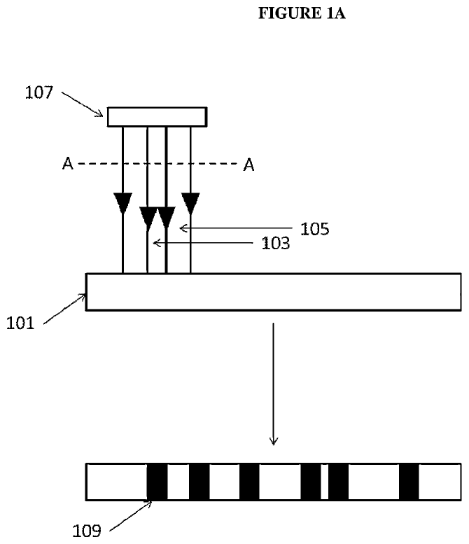

FIG. 1A schematically illustrates conversion of the organic luminescent precursor composition to the organic luminescent material composition according to some embodiments. A recording medium 101 containing the organic luminescent precursor in a first layer thereof, is irradiated by a light source 107 of the writing apparatus.

The recording medium may take any form configured to be written to by a writing apparatus, for example a disc. The disc may contain a single writeable layer comprising or consisting of the composition, or may contain two or more writeable layers. The disc may be single sided or double sided. Because optical transition rate due to 2-photon absorption depends on the square of the light intensity, it is particularly suited to writing to two or more layers of a recording medium.

The recording medium is irradiated with write beam, e.g. laser, 103 having a first wavelength λ₁ and write inhibition beam, e.g. laser, 105 which surrounds the write beam and which has a write inhibition wavelength λ₂.

Upon irradiation by the write beam, a material of the composition may absorb two photons of the write wavelength λ₁ causing excitation from a ground state, via a virtual state, to an excited state. The energy 2hc/λ₁ absorbed by the absorbing material is at least the same as or higher than that of the ground state—excited state energy gap of the material.

Intensity of the write beam to achieve 2-photon absorption is preferably at least 50 mW/cm², optionally in the range of 75-300 mW/cm².

Optionally, λ₁ is at least 600 nm, optionally at least 700 nm, optionally in the range of about 600-1000 nm.

Two-photon absorption is described in “Three-Dimensional Microfabrication Using Two-Photon Polymerisation”, Ed. Tommaso Baldacchini, Elsevier 2016, the contents of which are incorporated herein by reference.

2-photon absorption by the organic luminescent precursor composition in a region 109 which is irradiated by the write beam and which is irradiated by little or none of the light of the write inhibition beam causes conversion of the organic luminescent precursor composition to an organic luminescent composition.

The recording medium may be configured to move relative to the light-source 107, e.g. rotate, such that a plurality of regions of the recording medium is written to.

FIG. 1B illustrates a cross-section of the write beam 103 and write inhibition beam 105.

FIG. 1C illustrates intensities of the write beam 103 and write inhibition beams 105.

The write beam has a full width at half maximum (FWHM) of λ₁/2NA wherein NA is the numerical aperture of the focusing optics. This may be greater than or equal to about 200 nm, optionally greater than or equal to about 300 nm.

With reference to FIGS. 1B and 1C, the write inhibition beam has a toroidal or “doughnut” region encompassing a maximum of the write inhibition beam and surrounding a central region encompassing a minimum of the write inhibition beam. The toroidal region surrounds and overlaps the FWHM of the write beam. With reference to FIG. 1C, the peak-to-peak distance of the write inhibition beam may be λ1/NA. The width of the toroidal region may be the FWHM of the write inhibition beam.

With reference to FIG. 1C, the intensity of the write inhibition beam is at a minimum within the area defined by the FWHM of the write beam. Preferably, the minimum of the write inhibition beam is aligned with the maximum of the write beam.

In the embodiment of FIG. 1C, the minimum intensity of the write inhibition beam in the area defined by the FWHM of the write beam is a non-zero value. Optionally, intensity of light of the write inhibition beam in the central region is at least 10 times lower than anywhere in the surrounding toroidal region. In other embodiments, it is zero in at least part of the area defined by the FWHM of the write beam.

The width of the written areas (i.e. writing resolution) may be less than 100 nm, optionally less than 80 nm or less than 50 nm, optionally at least 5 or 10 nm. In this way, data may be written at below a diffraction limit of the write wavelength.

Reading apparatus configured to read data recorded on the recording medium may comprise a light source configured to emit an excitation beam onto the recording medium wherein the excitation beam has a wavelength at which the organic luminescent material luminesces.

The written recording medium may be read by stimulated emission depletion (STED) in which the excitation beam is surrounded by a deactivation beam such that only organic luminescent material irradiated by the excitation beam in a focal area emits light. The skilled person will understand how the focal area may be adjusted by altering the properties of the pupil plane of an objective lens. STED is described in more detail in, for example, Gu et al, “Nanomaterials for optical data storage”, Nature Reviews Materials, Vol 1, p. 1-14, December 2016, the contents of which are incorporated herein by reference.

Organic Luminescent Precursor Composition

The organic luminescent precursor composition of a first layer described herein may contain an inhibitor which, upon irradiation with the write-inhibit wavelength, inhibits conversion of the organic luminescent precursor composition to the organic luminescent material composition containing an organic luminescent material. Additionally or alternatively, an inhibitor may be disposed in a second layer of the recording medium. The second layer may or may not be adjacent to the first layer. It will be understood that the write inhibit and write beams will in use be incident on the first and second layers.

According to some embodiments of the present disclosure, the organic luminescent precursor composition contains an initiator and a precursor of the organic luminescent material. The initiator may, upon irradiation with the write wavelength, undergo a 2-photon absorption and initiate a reaction in which the organic luminescent precursor material is converted to an organic luminescent material. The inhibitor according to these embodiments may inhibit the activity of the initiator.

According to some embodiments of the present disclosure, the organic luminescent precursor composition contains an organic luminescent material bound to a luminescence quencher. Upon irradiation with the write wavelength and 2-photon absorption by this material, the luminescence quencher may be cleaved from the organic luminescent material and/or the luminescence quencher may be converted to a non-quenching form. The inhibitor according to these embodiments may inhibit such cleavage or conversion of the luminescence quencher.

It will be understood that cleavage may be a unimolecular process, i.e. not requiring the presence of a co-reactant such as an initiator. In some embodiments as described above, the organic luminescent precursor_composition contains an organic luminescent precursor material which converts to an organic luminescent material.

According to some further embodiments of the present disclosure, the organic luminescent precursor composition contains an organic luminescent material mixed with a luminescence quencher. The luminescence quencher may, upon irradiation with the write wavelength and 2-photon absorption, convert to a non-quenching form. The inhibitor according to these embodiments may inhibit such conversion of the luminescence quencher.

A wide range of organic luminescent materials and quenching groups are known to the skilled person, combinations of which may be used as described herein either as a single molecule organic luminescent precursor material or a mixture of an organic luminescent material and a quencher material.

The composition may contain a matrix material.

The organic luminescent material may be a fluorescent or phosphorescent material.

The organic luminescent material may be non-polymeric material or polymeric.

In the case where the organic luminescent material is formed from a precursor thereof, both the organic luminescent precursor and the organic luminescent material are non-polymeric; the organic luminescent precursor is non-polymeric and the organic luminescent material is a polymer; or both the organic luminescent precursor and the organic luminescent material are polymers.

In some embodiments, the extent of conjugation of the organic luminescent material is greater than the extent of conjugation of the organic luminescent precursor. The extent of conjugation of a material as described herein may be the largest number of atoms in a path of alternating single and double bonds.

The organic luminescent precursor may undergo an oligomerisation or polymerisation. An exemplary conversion of an organic luminescent precursor to an organic luminescent material in which the extent of conjugation is increased is illustrated in Scheme 1 wherein Ar in each occurrence is independently a substituted or substituted aryl or heteroaryl group:

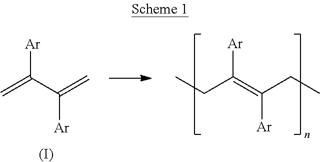

Optionally, Ar groups are selected from:

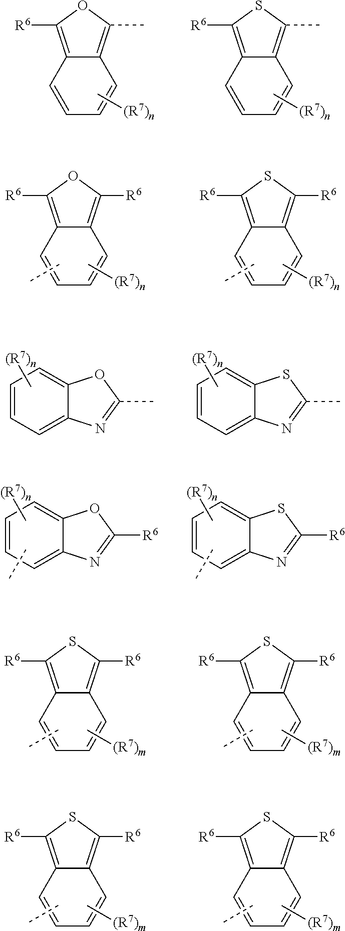

wherein R⁶ in each occurrence is independently H or a substituent; R⁷ independently in each occurrence is a substituent; m is 0, 1, 2 or 3; n is 0, 1, 2, 3 or 4; and --- represents a binding position of Ar in the organic luminescent precursor of formula (I).

Optionally, R⁶ groups which are not H or a direct bond and R⁷ groups (where present) are each independently selected from the group consisting of F; CN; NO₂; and C₁₋₂₀ alkyl wherein one or more non-adjacent, non-terminal C atoms may be replaced with O, S, CO or COO and wherein one or more H atoms of the alkyl may be replaced with F. In some embodiments, the brightness of a written region may be controlled by controlling the extent of conversion of the organic luminescent precursor composition to the organic luminescent composition, or extent to which the activity of a luminescent quencher is reduced. This may be controlled by, for example, controlling the duration and/or intensity of irradiation of the precursor composition by the write beam. The resultant written recording medium may thereby store data in a greyscale, rather than binary, form.

In some embodiments, the organic luminescent composition contains a plurality of different organic luminescent materials having different emission peak wavelengths.

One or more, optionally all, of the plurality of organic luminescent materials may be formed from a corresponding one or more organic luminescent precursors, each having an associated initiator. A first of the one or more initiators may, upon irradiation at a first write wavelength, selectively initiate conversion of a first of the one or more luminescent precursors to a first luminescent material. If present a second initiator may, upon irradiation at a second write wavelength, selectively initiate conversion of a second luminescent precursor to a second luminescent material.

One or more, optionally all, of the plurality of organic luminescent materials may have an associated luminescent quencher bound thereto or mixed therewith. A first of the one or more quenchers may, upon irradiation at a first write wavelength, selectively be deactivated. If present a second quencher may, upon irradiation at a second write wavelength, selectively be deactivated.

One or more of the plurality of organic luminescent materials may be formed from an organic luminescent precursor in the precursor composition and one or more of the plurality of organic luminescent materials may be associated with a luminescent quencher in the precursor composition.

Initiator

In the case where the organic luminescent precursor composition comprises an initiator, the initiator may be a material which, in its ground state, does not react with the organic luminescent precursor material.

In some embodiments, the initiator forms a reactive species upon irradiation and absorption, optionally 2-photon absorption, at the write wavelength. Optionally, no component of the organic luminescent precursor composition in its ground state other than the initiator absorbs energy and forms an excited state or reactive species at the write wavelength.

The reactive species may be a radical compound for initiation of a radical chain reaction. Optionally, the radical compound is formed by irradiation at the write wavelength of an initiator compound having an O—O or N—O bond, for example Irgacure® OXE 01 available from BASF. Optionally, the initiator compound comprises a phenone group, for example Irgacure® 184.

In some embodiments, the initiator reacts with a co-initiator upon irradiation at the write wavelength to form radicals, wherein the co-initiator undergoes 2-photon absorption. Exemplary initiators which form a radical upon reaction with a co-initiator include, without limitation, ketones such as camphorquinone and bis(diethylamino)benzophenone. Exemplary co-initiators include, without limitation, ethyl 4-(dimethylamino)benzoate N-phenylglycine 4,N,N-trimethylaniline.

Inhibitor

According to some embodiments of the present disclosure, the composition contain an inhibitor which, upon irradiation at the write inhibit wavelength, inhibits conversion of the organic luminescent precursor composition to the organic luminescent composition. Optionally, no component of the organic luminescent precursor composition in its ground state other than the inhibitor absorbs energy at the write inhibit wavelength.

According to some embodiments of the present disclosure, a first layer of a recording medium comprises the composition and a second layer comprises the inhibitor, e.g. a second layer comprising a matrix material as described herein and the inhibitor.

The inhibitor may deplete the intensity of the write wavelength beam in the write inhibit region such that the number of photons available for formation of the organic luminescent composition is below a threshold.

In some embodiments, the inhibitor inhibits activation of the initiator and, therefore, conversion of an organic luminescent precursor material to an organic luminescent material.

In some embodiments the inhibitor is a material which, upon absorption of light of the write inhibit wavelength, forms an excited state which is capable of absorbing light of the write wavelength.

Inhibitors according to these embodiments are referred to hereinafter as reverse saturable dye inhibitors. Exemplary reverse saturable dyes include, without limitation quinolone-indanediones such as Quinolone Yellow and diphenyl diazenes such as Disperse Orange.

In some embodiments, the inhibitor absorbs little or no light at the write wavelength but changes structure upon absorption of light of the write inhibit wavelength, e.g. by isomerisation or a non-isomerising conversion e.g. a cyclisation, to a material which absorbs the write wavelength. Inhibitors according to these embodiments are referred to hereinafter as photochromic inhibitors. Exemplary photochromic inhibitors include, without limitation, dithiopheno-cyclopentenes and dithiophenoanthracenes, for example:

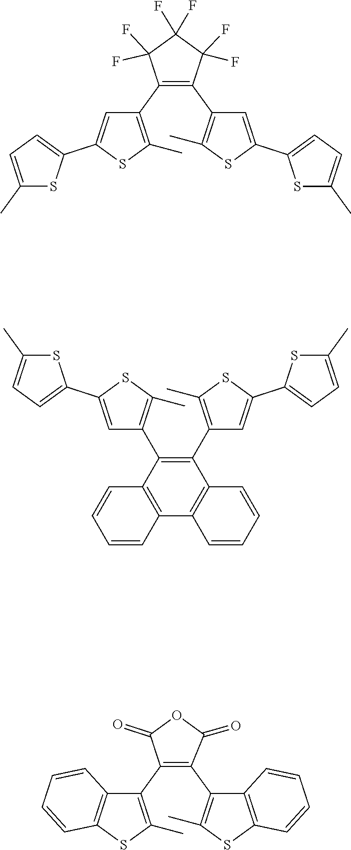

In some embodiments, the inhibitor forms an excited state upon exposure to the write inhibit wavelength in which electrons may be transferred to or from an excited state of the initiator formed by exposure of the initiator to the write wavelength. The inhibitor according to this embodiment is referred to hereinafter as a photo induced electron transfer quencher (PETQ).

An exemplary PETQ is Eosin Y, illustrated below as an anion of a salt:

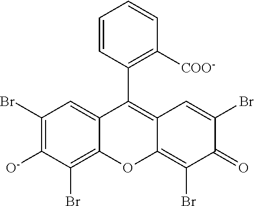

Matrix

The composition preferably comprises a matrix comprising one or more polymers. The organic luminescent material or precursor thereof and, where present, the quencher, the inhibitor and/or the initiator are preferably disposed in a matrix comprising one or more polymers. The matrix is suitably transparent to the write wavelength and the write inhibit wavelength of the composition and to the excitation wavelength for reading following recording of data.

Exemplary matrix polymers include, without limitation, polystyrene, polyacrylates, polymethacrylates (e.g. PMMA) and polycarbonates.

In some embodiments, the material or materials of the composition, e.g. organic luminescent material or precursor thereof, and one or more of the inhibitor, quencher and the initiator are each homogenously dispersed in the matrix.

In some embodiments, one or more of the organic luminescent precursor, the inhibitor and the initiator is covalently bound to a matrix polymer.

### Examples

Monomer Synthesis

Monomer 1 was prepared according to Scheme 1:

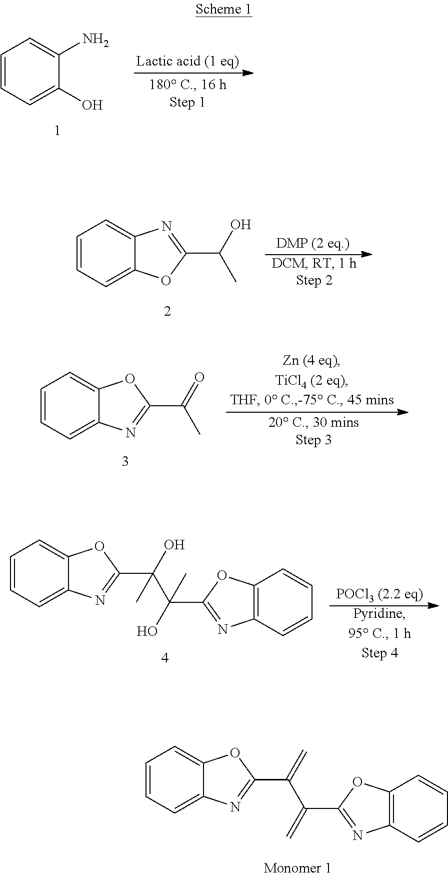 [SMILES: Nc1ccccc1O ; CC(O)c1nc2ccccc2o1 ; CC(=O)c1nc2ccccc2o1 ; CC(O)(c1nc2ccccc2o1)C(C)(O)c1nc2ccccc2o1 ; C=C(C(=C)c1nc2ccccc2o1)c1nc2ccccc2o1]

Step 1: Synthesis of Intermediate 2

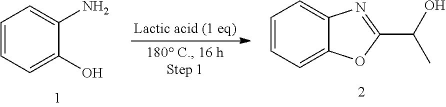

2-Aminophenol (100 g, 916 mmol) and 2-hydroxypropanoic acid (82.5 g, 916 mmol) were placed in a 500 mL round-bottomed flask equipped with a magnetic stirrer, oil-bath, condenser and nitrogen bubbler and refluxed for 16 hours at 150° C. The mixture was then heated to 180° C. 27 g of Intermediate 2 was isolated by distillation and used without further purification.

Step 2: Synthesis of Intermediate 3

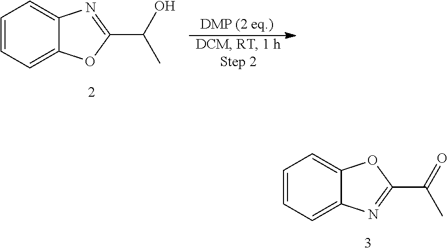

To a stirred solution of 1-(1,3-benzoxazol-2-yl)ethan-1-ol (Intermediate 2, 27 g, 165 mmol) in dichloromethane (555 mL) in a 1 L multi neck round bottomed flask equipped with a magnetic stirrer and a nitrogen bubbler was added Dess-Martin Periodinane (139 g, 327 mmol) portion-wise.

The reaction mixture was stirred at room temperature for an hour and then diluted with DCM (1 L) and passed through celite bed.

The filtrate was washed with water (500 mL) followed by sodium bicarbonate solution (1 L), filtered through celite bed and then layers were separated. The organic layer was concentrated to give crude 25 g of product which purified using a silica gel column (60-120 mesh) using DCM in hexane as an eluent.

10 g of Intermediate 3 was isolated with 99.7% LCMS purity.

¹H-NMR (400 MHz, CDCl₃): δ 7.92 (dd, J=0.40 Hz, 1H), 7.67 (d, J=8.40 Hz, 1H), 7.58-7.54 (m, 1H), 7.50-7.46 (m, 1H), 2.83 (s, 3H).

Synthesis of Intermediate 4

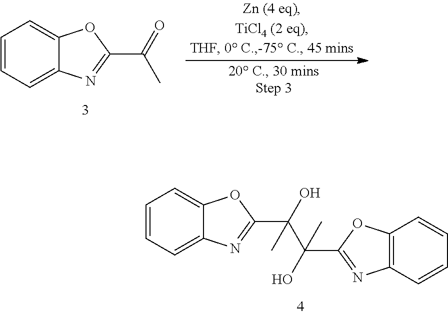 [SMILES: CC(=O)c1nc2ccccc2o1 ; CC(O)(c1nc2ccccc2o1)C(C)(O)c1nc2ccccc2o1]

TiCl₄ (16.3 mL, 148 mmol) was added to Zinc Powder (19.4 g, 297 mmol) in THF (360 mL) at 0° C. in a 1 L round-bottomed flask connected to a magnetic stirrer, condenser, oil-bath and nitrogen bubbler.

The reaction mixture was heated to 75° C. with stirring for 45 minutes and then cooled to 20° C. To the reaction mixture was added 1-(1,3-benzoxazol-2-yl)ethan-1-one (Intermediate 3, 12 g, 74.4 mmol) in THF (120 mL) at 20° C. The reaction mixture was stirred for 30 minutes and then quenched with water (1 L) and extracted with ethyl acetate (1 L). The organic layer was concentrated to give crude product 11 g, 52% purity by LCMS. The solid was taken in ethyl acetate (20 mL), stirred at 0° C. for 10 mins and filtered. 5 g of Intermediate 4 isolated with 94% HPLC purity was obtained.

Synthesis of Monomer 1

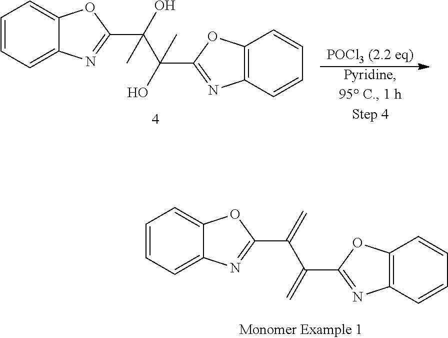 [SMILES: CC(O)(c1nc2ccccc2o1)C(C)(O)c1nc2ccccc2o1 ; C=C(C(=C)c1nc2ccccc2o1)c1nc2ccccc2o1]

2,3-bis(1,3-benzoxazol-2-yl)butane-2,3-diol (Intermediate 4, 1.3 g, 4 mmol) was taken in Pyridine (13 mL) in a 25 mL 2-neck round-bottomed flask connected to a magnetic stirrer, oil-bath, condenser and nitrogen bubbler. The reaction mixture was cooled to 0° C. and POCl₃ (0.82 mL, 8.80 mmol) was added drop-wise. The reaction mixture was then heated to 95° C. for 1.5 h. The mixture was turbid at 95° C. for 10 mins and then slowly become a clear solution. The reaction mixture was diluted with hexane (100 mL) and washed with water (150 mL) followed by 1.5 N HCl (200 mL). The hexane layer separated and concentrated to give 0.35 g of product which was purified by combi column purification using hexane/ethyl acetate as eluent. The desired product eluted at ˜10% ethyl acetate in hexane. 80 mg of Monomer 1 was isolated with 99.8% HPLC purity.

¹H-NMR (400 MHz, CDCl₃): δ 7.70-7.68 (m, 2H), 7.55-7.53 (m, 2H), 7.38-7.29 (m, 4H), 6.69 (s, 2H), 6.11 (s, 2H).

Single Photon Writing in Solution

A solution of 5% (w/v) Monomer 1 and 5% (w/v) Irgacure 184 (1-Hydroxycyclohexyl phenyl ketone) initiator was made up in chloroform. Care was taken to prepare the solution under yellow lighting at all times and solution was stored in an amber vial. For the control experiment, the Irgacure was omitted.

A cell was constructed using a standard 75 mm×25 mm microscope slide as a base, a 2-sided adhesive gasket as the walls, and a 40 mm×25 mm coverslip (150 microns thickness) as the top. The adhesive gasket was laser cut from Grace Bio-Labs SecureSeal™ adhesive sheets (120 microns thick), the coverslip had two portholes laser cut into the ends to allow filling of the solution with a pipette. After filling of the cell with the solution the portholes were sealed with Grace Bio-Labs adhesive seal tabs.

For measurement, an Olympus BX60 upright epifluorescence microscope was used with a filter set utilising the 365 nm UV line from a mercury lamp as an excitation source. The camera port on the microscope was connected by fibre optic cable to an Ocean Optics USB2000+ diode array spectrometer. To measure the reaction of the solution to UV excitation the spectrometer was set up to integrate the spectrometer counts between 400 nm and 500 nm and take measurements every second. Then the sample was placed under the microscope, the shutter was opened and the spectrometer started recording simultaneously. The UV light intensity from the microscope was measured at 7.3 mW/cm². Samples with and without initiator were exposed.

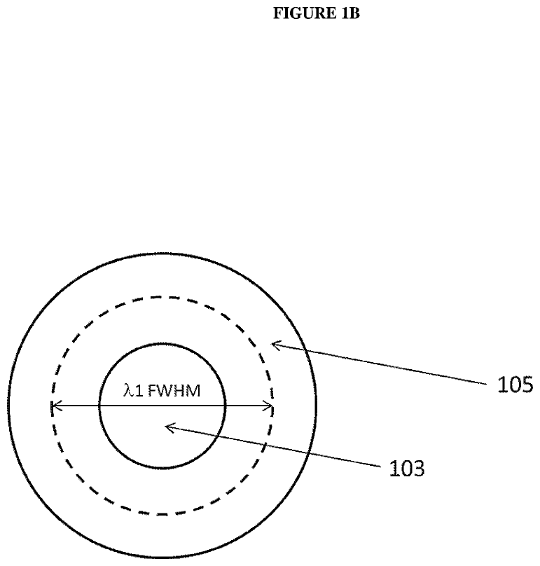

With reference to FIG. 2, the photoluminescence increase for a solution containing the initiator showed a more than 20 fold increase in fluorescence whereas a solution with no initiator showed no change.

Two-Photon Writing in a PMMA Matrix by Free-Radical Initiated Polymerisation

A film was spin-coated from a solution of 85.5 wt % PMMA (poly(methy methacrylate) Mw˜120,000); 4.5 wt % Irgacure 184 and 10 wt % Monomer 1 in CHCl₃ onto 25 mm glass substrates.

For the two photon writing a frequency a doubled DPSS Nd:YAG laser with a pulse length of 1 ns and a frequency of 20 Hz was used (CryLas FDSS 532-150), the laser beam was focused to a 60 um Gaussian spot on the surface of the sample, and a pulse energy of 100 microjoules was measured. Using an XY electronic translation stage (OptoSigma osMS20-35) the sample was scanned in a serpentine raster pattern under the laser beam at a rate of 1 micron/s.

The same microscope system was used for visualising the written area, except the spectrometer was replaced with a CCD camera (thorlabs BC106). A line profile was taken from the CCD image and used to measure an average PL increase of 60% over the written area.

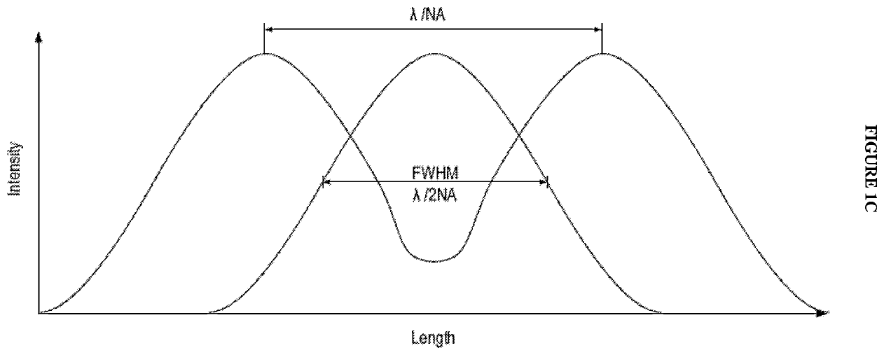

FIG. 3A shows a greyscale fluorescence image from the camera showing the raster scanned area as a brighter square in the centre of the image.

FIG. 3B showing the raster scan pattern superimposed over the image, showing the increase of brightness in the raster scanned area.

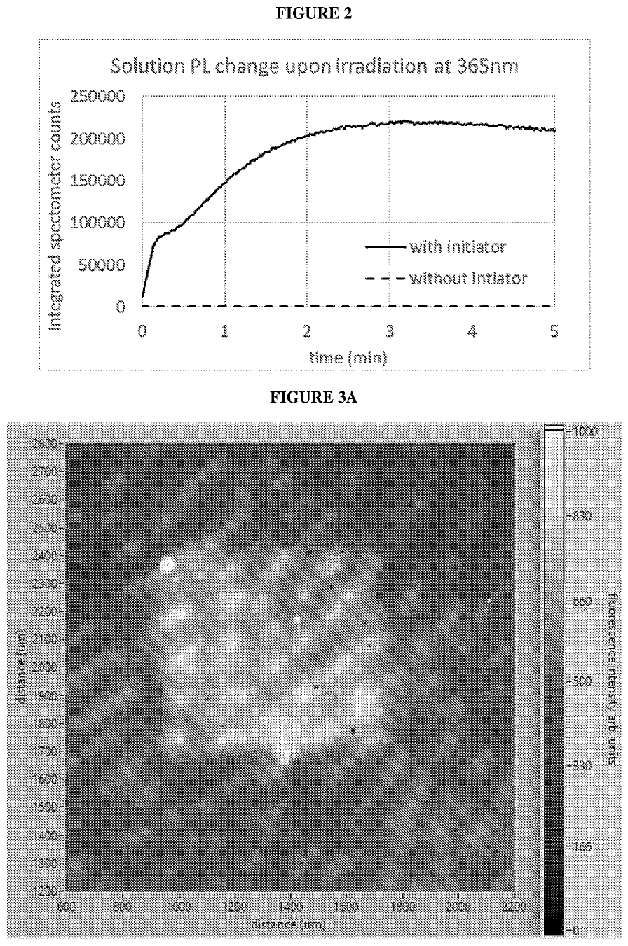

FIG. 4 is a profile through the centre of the image of FIG. 3A showing higher photoluminescence counts in the exposed area. The photoluminescence counts shown in FIG. 4 are normalised to the non-written area, and dotted lines show the edges of the written area.

Two Photon Writing in a PMMA Matrix (Cleaved Emitter Approach)

A unimolecular bond-cleavage approach was implemented using organic luminescent precursors 1 and 2, in which the wavy line illustrates the point of cleavage between the emissive group (benzothiadiazole and coumarin-containing groups, respectively) and the quencher.

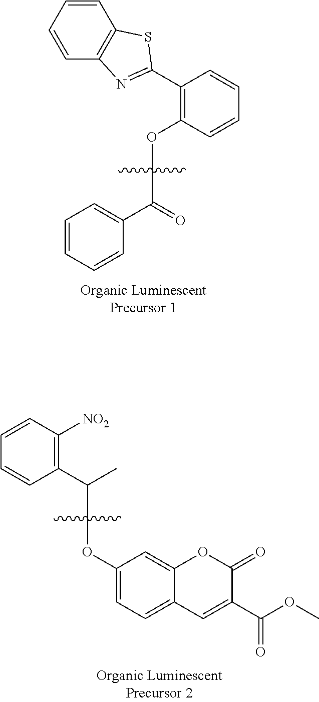

A blend of 10 wt % organic luminescent precursor 1 or 2 and 90 wt % PMMA was spin-coated from chloroform to produce a film thickness of 6.6 microns. Written fluorescence was confirmed via single photon exposure (UV—365 nm), and the aforementioned laser setup was used to produce two photon writing with a pulse energy of 43 microjoules. The written linewidth was ˜20 microns.

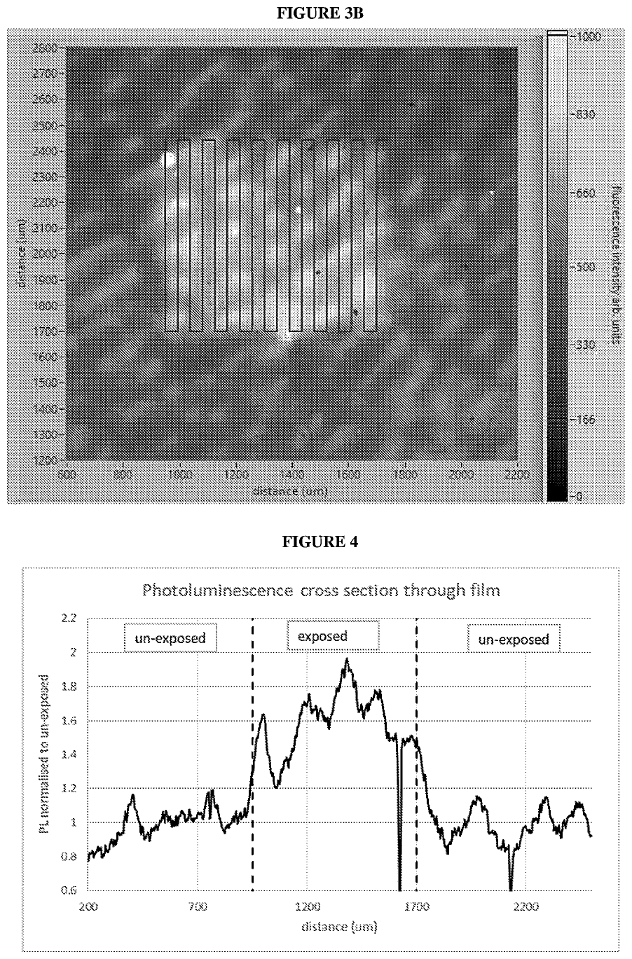

A factor of ten enhancement in fluorescence was demonstrated following writing with the laser. This can be seen in FIG. 5, in which the composition containing Organic Luminescent Precursor 1 produces areas of higher luminance written in the pattern of the raster scan.

Combination of Write and Write Inhibition Beam

A first layer was formed by spin-coat A first layer was formed as a capillary cell of 57:38:5 (SR399 acrylate monomer:SR444 acrylate monomer:Irgacure184) % wt. of 120 microns approximate thickness. A 50 mM solution of Inhibitor 1 in PMMA was deposited as an additional layer placed adjacent to the first by spin-coating.

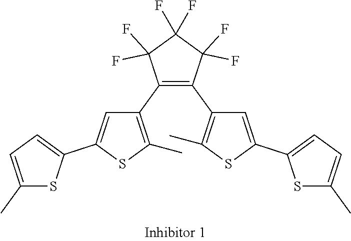

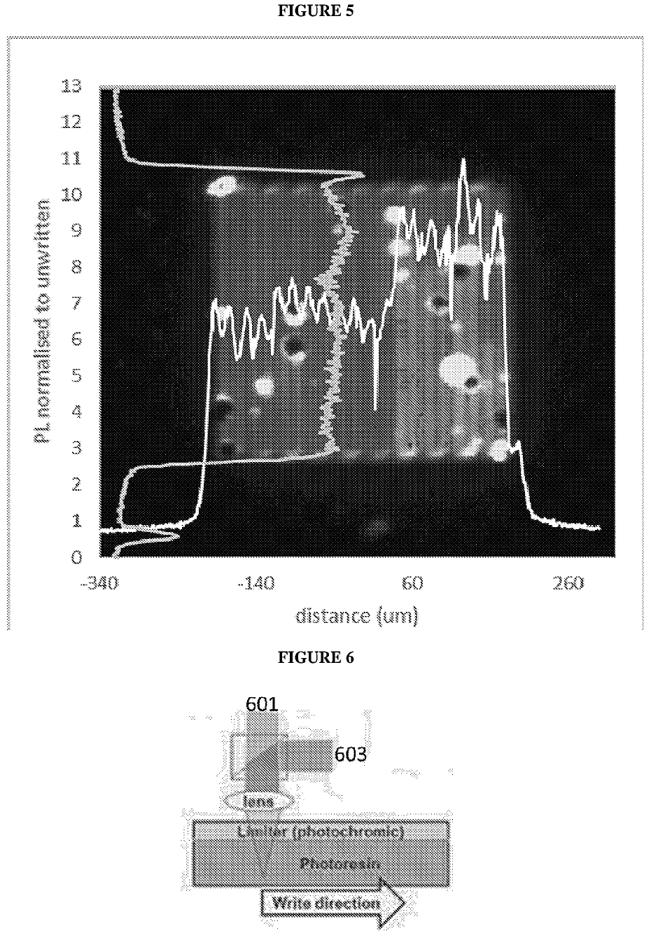

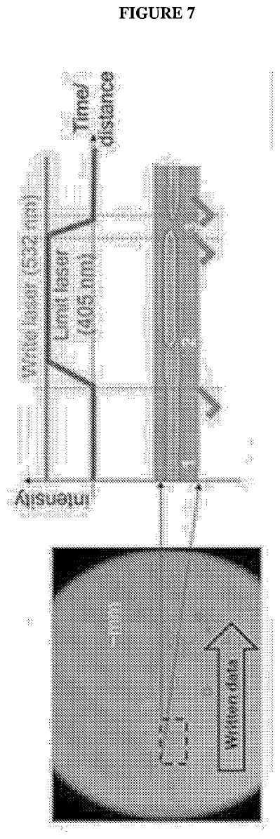

The two-layer structure was scanned with a write laser 601 (532 nm) and, for part of the scan across the structure, with a collinear write inhibition laser 603 (405 nm) using apparatus illustrated in FIG. 6. Writing was found to be inhibited in the regions of the scan in which the write inhibition laser was on, as shown in FIG. 7 in which the write laser wrote to region 1 of the first layer during non-operation of the write-inhibit laser. Although some writing was observed in the region 2 in which both the write and write inhibit lasers were on, the different depth of writing within region 2 is attributed to a write effect of the write-inhibit laser which can be removed by selection of the composition of the first layer.

1. A method of recording data to a first layer of a recording medium comprising an organic luminescent precursor composition, the method comprising irradiating the organic luminescent precursor composition with a first light beam and a second light beam, the first light beam having a write wavelength for conversion of the organic luminescent precursor composition to an organic luminescent composition and the second light beam having a write inhibition wavelength for inhibiting conversion of the organic luminescent precursor composition to the organic luminescent composition, wherein: the second light beam has a central area and a surrounding area; an intensity of the second light beam in the central area is lower than an intensity of the second light beam in the surrounding area; the first light beam extends across the central area; and the surrounding area of the second light beam surrounds the first light beam.

2. The method according to claim 1 wherein the organic luminescent precursor composition comprises an initiator wherein the initiator forms, upon irradiation with light of a write wavelength, a reactive material for initiating a conversion of an organic luminescent precursor material of the organic luminescent precursor composition to an organic luminescent material.

3. The method according to claim 2 wherein the composition further comprises a co-initiator which, upon exposure to the write wavelength, reacts with the initiator to form the reactive material.

4. The method according to claim 2 wherein the organic luminescent precursor material has a lower extent of conjugation than the organic luminescent material.

5. The method according to claim 2 wherein the organic luminescent precursor is a non-polymeric compound.

6. The method according to claim 4 wherein the organic luminescent material is a polymer.

7. The method according to claim 2 wherein the reactive material is a radical compound.

8. The method according to claim 1 wherein the recording medium comprises an inhibitor wherein the inhibitor, upon irradiation with light of the write inhibition wavelength, inhibits the conversion of the organic luminescent precursor composition to the organic luminescent composition.

9. The method according to claim 8 wherein the organic luminescent precursor composition comprises the inhibitor.

10. The method according to claim 8 wherein the inhibitor is disposed in a second layer of the recording medium.

11. The method according to claim 8 wherein the inhibitor, upon absorption of light of the write inhibit wavelength, forms an excited state which absorbs light of the write wavelength.

12. The method according to claim 8 wherein the inhibitor, upon absorption of light of the write inhibit wavelength, converts to a material which absorbs light of the write wavelength.

13. The method according to claim 8 wherein the inhibitor, upon absorption of light of the write inhibit wavelength, forms an excited state capable of receiving electrons from or transferring electrons to an excited state of the initiator.

14. The method according to claim 1 wherein the organic luminescent precursor composition comprises an organic luminescent material bound to a luminescence quencher and wherein the recording medium further comprises an inhibitor wherein:
the luminescent quencher is cleaved from the organic luminescent material or is converted to a non-quenching form upon irradiation of the organic luminescent material bound to a luminescence quencher, upon irradiation with light of the write wavelength; and
the inhibitor, upon irradiation with light of the write inhibition wavelength, inhibits the cleavage or conversion of the luminescent quencher.

15. The method according to claim 1 wherein the organic luminescent precursor composition comprises an organic luminescent material mixed with a luminescence quencher and wherein the recording medium further comprises an inhibitor wherein:
the luminescent quencher is, upon irradiation with light of the write wavelength, converted to a non-quenching form; and
the inhibitor, upon irradiation with light of the write inhibition wavelength, inhibits the conversion of the luminescent quencher.

16. The method according to claim 1 wherein the composition comprises a matrix comprising at least one polymer.

17. The method according to claim 1 wherein the recording medium is a disc.

18. A composition comprising:
an organic luminescent precursor material,
an initiator for forming, upon irradiation with light of a write wavelength, a reactive material for initiating a conversion of the organic luminescent precursor to an organic luminescent material; and
an inhibitor for inhibiting formation of the reactive material upon irradiation with light of a write inhibition wavelength.

19. A composition comprising:
a luminescent quencher bound to or mixed with an organic luminescent material which, upon irradiation with light of a write wavelength, cleaves from the organic luminescent material or converts to a non-quenching form; and
an inhibitor for inhibiting said cleavage or conversion.
